(19) United States
(12) Patent Application Publication
(10) Pub. No.: US 2026/0185822 A1
(43) Pub. Date: Jul. 2, 2026

(54) METROLOGY SYSTEM UTILIZING FULL RANGE DETECTION

(71) Applicant: Mitutoyo Corporation, Kanagawa-ken (JP)

(72) Inventors: Zachary William FOX, Kenmore, WA (US); Nick HARTMANN, Kirkland, WA (US)

(21) Appl. No.: 19/005,052

(22) Filed: Dec. 30, 2024

(51) Int. Cl. G01B 11/06

(52) U.S. Cl. CPC G01B 11/0675

(57) ABSTRACT

A metrology system includes a light portion that outputs light and a branching portion. A part of the light output from the light portion is branched as reference light directed along a reference optical path, and part of the light is branched as measurement light directed along a measurement optical path to be reflected by a workpiece that is to be measured. The metrology system is configured to: receive combined light comprising reference light from the reference optical path and measurement light from the measurement optical path; and convert the combined light into a distance indicating electrical signal. At least one of the reference optical path or the measurement optical path comprises a dispersion portion, for which an imbalanced dispersion between the reference optical path and the measurement optical path results (e.g., which enables disambiguation between signal peaks and a corresponding determination of a distance to the workpiece).

### BACKGROUND

### Technical Field

This disclosure relates to precision metrology, and more particularly to precision workpiece surface measurement devices and systems.

### Description of the Related Art

Quality control of objects (e.g., workpieces) that include specific surface profiles (e.g., produced by molding and/or machining, or the like), is becoming increasingly demanding in terms of throughput, measurement resolution, and accuracy. Ideally, such workpieces should be measured/inspected to ensure proper dimensions, function, etc. However, very precise measurement tolerances (e.g., in some instances micron level or finer) may be required in order to confirm a workpiece surface with desired characteristics for some applications.

Various precision metrology systems may be used for workpiece surface measurements and inspection. For example, in some instances a metrology system that performs such operations may utilize a type of optical coherence tomography (OCT), such as frequency-modulated continuous wave (FMCW) technology, which can determine a distance to a target (e.g., to a point on a workpiece surface, for which distances to multiple points on a workpiece surface may be determined as part of measurement operations for the workpiece surface). An important part of such systems and/or other comparable measurement systems is the effective measurement range. Configurations that may improve or otherwise enhance such metrology systems (e.g., for measuring and inspecting surfaces of workpieces, etc.) would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to one aspect, a metrology system is provided, which includes a light portion, a branching portion, and a detector and processing portion. The light portion outputs light. The branching portion branches a part of the light output from the light portion as reference light that is directed along a reference optical path, and branches at least a part of the remaining light as measurement light that is directed along a measurement optical path to be reflected by a workpiece that is to be measured. The detector and processing portion is configured to: receive combined light comprising reference light from the reference optical path and measurement light from the measurement optical path that is reflected by the workpiece; and convert the combined light into a distance indicating electrical signal. At least one of the reference optical path or the measurement optical path comprises a dispersion portion, for which an imbalanced dispersion between the reference optical path and the measurement optical path results at least in part from the dispersion portion.

According to another aspect, a method for operating the metrology system is provided. The method includes generally two steps:
receiving combined light comprising reference light from the reference optical path and measurement light from the measurement optical path that is reflected by the workpiece, wherein at least one of the reference optical path or the measurement optical path comprises a dispersion portion, for which an imbalanced dispersion between the reference optical path and the measurement optical path results at least in part from the dispersion portion; and converting the combined light into a distance indicating electrical signal and determining a distance to the workpiece.

### BRIEF DESCRIPTION OF THE DRAWINGS

FIG. 1 is a block diagram of a metrology system including an interferometer portion and a circuitry portion;

FIG. 2 is a block diagram illustrating a first implementation of an interferometer portion as may be included in a metrology system such as that of FIG. 1;

FIG. 3 is a block diagram illustrating a second implementation of an interferometer portion as may be included in a metrology system such as that of FIG. 1;

FIG. 4 is a block diagram illustrating an implementation of a circuitry portion as may be included in a metrology system such as that of FIG. 1;

FIGS. 5A-5D are diagrams illustrating certain operating principles of a metrology system such as that of FIG. 1 and in which a measurement optical path length is longer than a reference optical path length;

FIGS. 6A-6D are diagrams illustrating certain operating principles of a metrology system such as that of FIG. 1 and in which a reference optical path length is longer than a measurement optical path length;

FIGS. 7A-7G are diagrams illustrating certain operating principles of a metrology system such as that of FIG. 1 and in which inclusion of a dispersion portion enables utilization of a full measurement range;

FIG. 8 is a diagram illustrating two signal peaks with different peak shapes as resulting from inclusion of a dispersion portion; and

FIG. 9 is a flow diagram illustrating an exemplary implementation of a routine for operating a metrology system.

### DETAILED DESCRIPTION

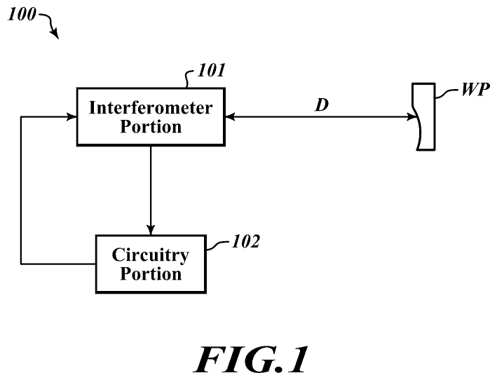

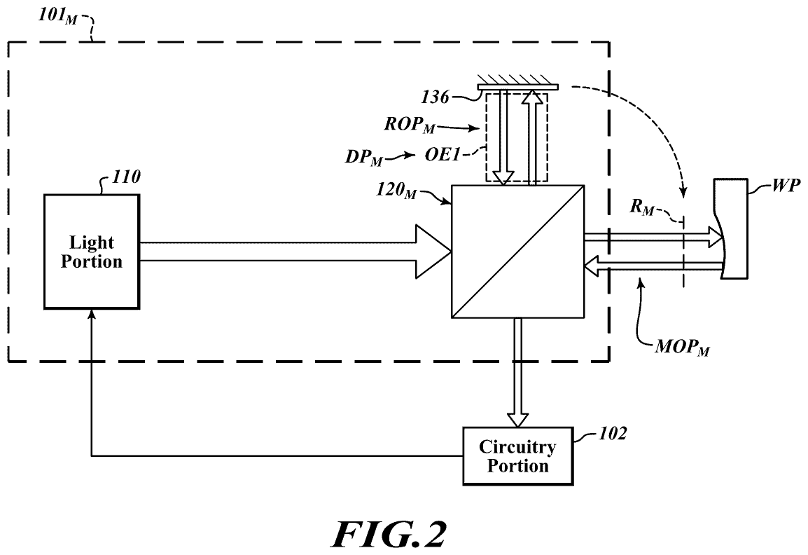

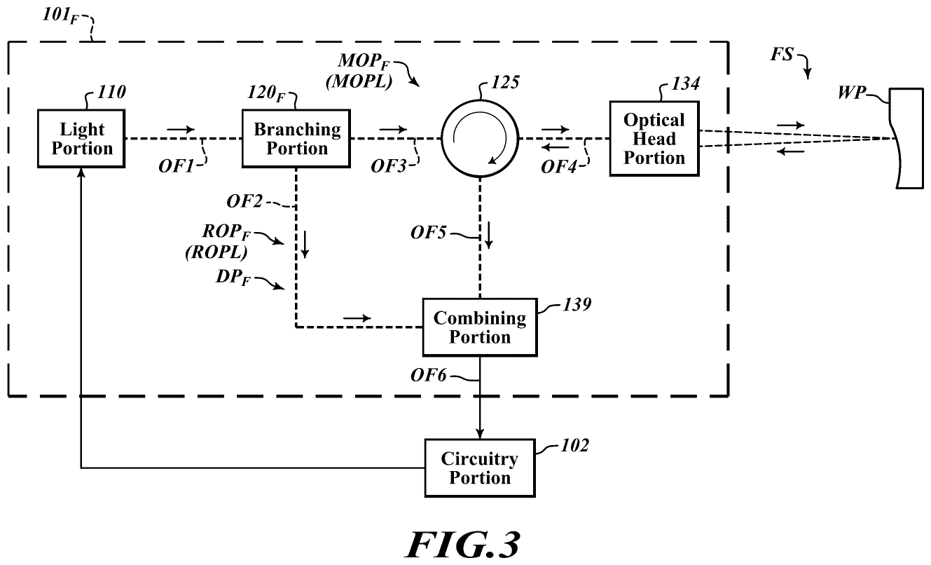

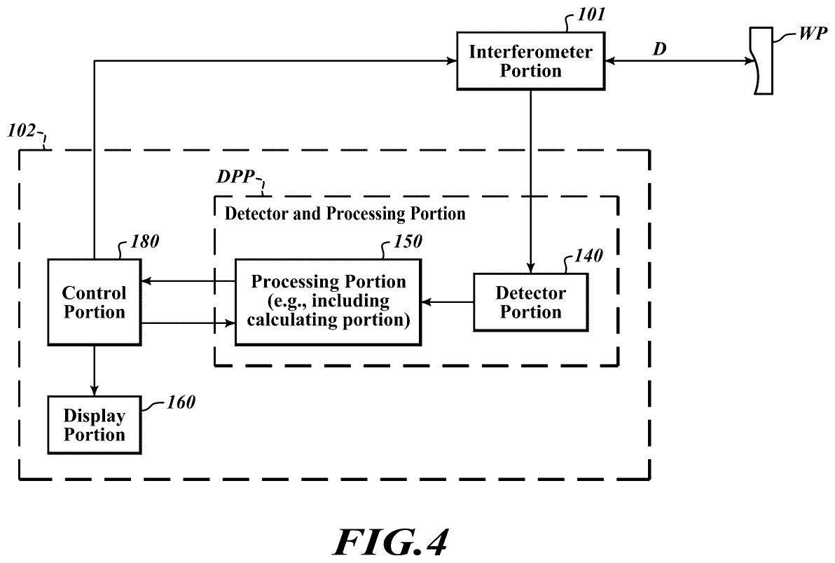

FIG. 1 is a block diagram showing a metrology system 100 together with a workpiece WP to be measured. As shown in FIG. 1, the metrology system 100 includes an interferometer portion 101 and a circuitry portion 102. The metrology system utilizes optical coherence tomography (OCT) techniques, such as frequency-modulated continuous wave (FMCW) techniques, as will be described in more detail below. Certain implementations of the interferometer portion 101 will be described in more detail below with respect to FIGS. 2 and 3. An implementation of the circuitry portion 102 will be described in more detail below with respect to FIG. 4.

In various implementations, the metrology system 100 is configured to determine a distance D to a workpiece. More specifically, the metrology system 100 optically measures a distance between the metrology system 100 and the workpiece WP. The metrology system 100 may also measure a three-dimensional shape and/or surface characteristics of the workpiece WP (e.g., by scanning the position of light irradiated on the workpiece WP, such as for measuring different points on a surface of the workpiece WP).

FIG. 2 is a block diagram illustrating a first implementation of an interferometer portion 101_{M} as may be included in a metrology system 100 such as that of FIG. 1. As shown in FIG. 2, the interferometer portion 101_{M} includes a light portion 110, a branching portion 120_{M} and a reference mirror 136. As will be described in more detail below, the interferometer portion 101_{M} directs light toward a workpiece WP (e.g., for measuring a distance to the workpiece WP).

In various implementations, the light portion 110 comprises a laser resonator and outputs laser light (e.g., the light portion 110 in FIGS. 2 and 3 may in some implementations also or alternatively be referenced as a laser portion 110). The light portion 110 may output, for example, frequency-modulated laser light. The light portion 110 may have a frequency shifter provided in the resonator and may output a laser for which the oscillation frequency changes linearly over time. In various implementations, the light portion 110 may comprise a frequency-shifted feedback laser.

The branching portion 120_{M} splits a portion of the light output by the light portion 110 as reference light and at least a portion of the remaining light as measurement light. As will be described in more detail below, the reference light is directed along a reference optical path ROP_{M} and the measurement light is directed along a measurement optical path MOP_{M}. In various implementations, the branching portion 120_{M} may comprise a splitter component (e.g., a beamsplitter, etc.) In various implementations, the splitter component may have a designated split ratio (e.g., 1:1, such that an approximately equal amount of light may be directed along each of the reference optical path ROP_{M} and the measurement optical path MOP_{M}).

In the reference optical path ROP_{M}, reference light branched from the branching portion 120_{M} is irradiated toward the reference mirror 136, which reflects the reference light back toward the branching portion 120_{M}. In the measurement optical path MOP_{M}, measurement light branched from the branching portion 120_{M} is irradiated toward the workpiece WP. Measurement light reflected from the workpiece WP is received back at the branching portion 120_{M}. In various implementations, a distance between at least part of the branching portion 120_{M} and the workpiece WP may be set as a distance D to be measured by the metrology system 100.

The branching portion 120_{M} combines the reflected measurement light with the reference light reflected by the reference mirror 136. In this way, FIG. 2 shows an example in which the branching portion 120_{M} also functions as a combining portion (e.g., for which in some implementations the branching portion may also or alternatively be referenced as a branching and combining portion 120_{M} or simply a combining portion 120_{M}). The branching portion 120_{M} outputs the combined light (e.g., including the reference light and the measurement light) to the circuitry portion 102 (e.g., to a detector portion 140 in the circuitry portion 102, as will be described in more detail below with respect to FIG. 4).

In various implementations, the reference optical path ROP_{M} may have a reference optical path length (e.g., as including the travel of the reference light to and from the reference mirror 136). Similarly, the measurement optical path MOP_{M} may have a measurement optical path length (e.g., as including the travel of the measurement light to and from the workpiece WP). In general, there may be a difference between the reference optical path length and the measurement optical path length. In the example of FIG. 2, a reference marker RM is provided which indicates a representation of the length of the reference optical path ROP_{M}, as shown in relation to the measurement optical path MOP_{M}. In this example, the measurement optical path MOP_{M} is indicated to have a greater length than the reference optical path ROP_{M}. In an alternative condition in which the reference optical path ROP_{M} had a greater length than the measurement optical path MOP_{M}, the measured surface of the workpiece WP would be shown before the reference marker RM (i.e., to the left of the reference marker RM in FIG. 2). As will be described in more detail below, the circuitry portion 102 may be configured to receive the combined light (i.e., comprising the combined reference light and measurement light), and to produce an output (e.g., which indicates a distance to the workpiece, and which correspondingly indicates a difference between the reference optical path length and the measurement optical path length).

In various implementations, an optical path length difference between the reference optical path length and the measurement optical path length may correspond to a propagation difference between the reference light and the measurement light, for which a propagation delay corresponding to the optical path length difference occurs in the reference light and the measurement light. As will be described in more detail below, by determining a signal that corresponds to the propagation delay (e.g., as determined utilizing the circuitry portion 102), a distance to the workpiece WP may be determined. More specifically, as noted above the measurement optical path length is a result of the distance to the workpiece (e.g., for which the measurement optical path length will be larger for longer distances to the workpiece, and will be smaller for shorter distances to the workpiece). Correspondingly, the propagation delay (e.g., which corresponds to a difference between the measurement optical path length and the known fixed reference optical path length) will be different for different distances to the workpiece. As will be described in more detail below, such relationships may be utilized for determining a measurement distance to a workpiece (e.g., in accordance with a determined signal that corresponds to the propagation delay and which correspondingly indicates an optical path length difference which indicates a measurement distance to the workpiece).

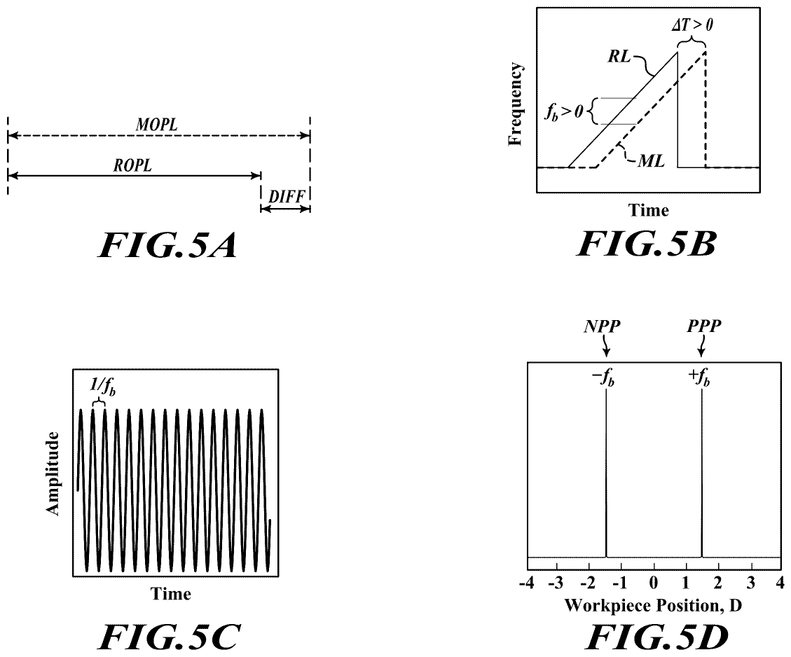

In accordance with principles as described herein, the interferometer portion 101_{M} of the metrology system includes a dispersion portion DP_{M}. In the example of FIG. 2, the dispersion portion DP_{M} is included in the reference optical path ROP_{M}, although in certain alternative implementations the dispersion portion may be included in the measurement optical path MOP_{F}. In the illustrated example, the dispersion portion DP_{M} comprises a high dispersion optical element OE1. In various implementations, the optical element OE1 may be at least semi-transparent for which light (e.g., reference light in the illustrated example) may pass through the optical element OE1, with the optical element OE1 causing dispersion of the light. As will be described in more detail below (e.g., with respect to FIGS. 5A-9), an imbalanced dispersion between the reference optical path and the measurement optical path results at least in part from the dispersion portion (e.g., as may be utilized as part of the process for determining a measurement distance to the workpiece WP).

FIG. 3 is a block diagram illustrating a second implementation of an interferometer portion 101_{F} as may be included in a metrology system 100 such as that of FIG. 1. As shown in FIG. 3, the interferometer portion 101_{F} includes a light portion 110, a branching portion 120_{F}, a circulator portion 125, an optical head portion 134 and a combining portion 139. Optical fibers OF1-OF6 are shown to connect the different portions for providing light to and/or from the different portions. More specifically, the light portion 110 is coupled to the branching portion 120_{F} by an optical fiber OF1. The branching portion 120_{F} is coupled to the combining portion 139 by an optical fiber OF2, and is coupled to the circulator portion 125 by an optical fiber OF3. The circulator portion 125 is coupled to the optical head portion 134 by an optical fiber OF4, and is coupled to the combining portion 139 by an optical fiber OF5. The combining portion 139 is coupled to the circuitry portion 102 by an optical fiber OF6.

As will be described in more detail below, the interferometer portion 101_{F} directs light toward a workpiece WP (e.g., for measuring a distance to the workpiece WP). In various implementations, the metrology system may optically measure a distance between the interferometer portion 101_{F} and the workpiece WP (e.g., and in various implementations may also measure a three-dimensional shape and/or surface characteristics of the workpiece WP, such as by scanning the position of light irradiated on the workpiece WP, such as for measuring different points on a surface of the workpiece WP).

The branching portion 120_{F} branches the light output from the light portion 110, with part of the light as reference light and at least some of the remaining light as measurement light. The branching portion 120_{F} is, for example, a fiber optic splitter (e.g., as may also or alternatively be referenced as a fiber optic coupler). In the example of FIG. 3, the branching portion 120_{F} supplies the measurement light to the circulator portion 125, and supplies the reference light to the combining portion 139.

The circulator portion 125 has a plurality of input/output ports. For example, the circulator portion 125 inputs a light from one port and outputs the light from the next port, and inputs a light from the next port and outputs the light from the port after next. FIG. 3 shows an example in which the circulator portion 125 has three input/output ports. In this case, the circulator portion 125 outputs the measurement light supplied from the branching portion 120_{F} to the optical head portion 134. Also, the circulator portion 125 outputs a light input from the optical head portion 134 (i.e., as reflected from the workpiece WP) to the combining portion 139.

The optical head portion 134 provides/radiates/directs the light input from the circulator portion 125 toward the workpiece WP. The optical head portion 134 includes, for example, a collimator lens. In this case, the optical head portion 134 first adjusts the light input from the circulator portion 125 via the optical fiber OF4 into a beam shape using the collimator lens, and then outputs the light.

Also, the optical head portion 134 receives a reflected light of the measurement light radiated onto the workpiece WP. The optical head portion 134 focuses the received reflected light onto the optical fiber OF4 with a collimator lens and supplies it to the circulator portion 125. In this case, the optical head portion 134 may include one common collimator lens, and the collimator lens may irradiate the workpiece WP with the measurement light, and may receive the reflected light from the workpiece WP. In various implementations, a distance between at least part of the optical head portion 134 and the workpiece WP may be defined as a distance D (e.g., which may in some implementations be characterized as a measurement distance D).

Alternatively, the optical head portion 134 may include a focusing lens. In this case, the optical head portion 134 focuses the light input from the circulator portion 125 via the optical fiber OF4 on the surface of the workpiece WP. The optical head portion 134 receives at least a part of the reflected light reflected from the surface of the workpiece WP. The optical head portion 134 focuses the received reflected light onto the optical fiber OF4 using the focusing lens and supplies the light to the circulator portion 125. Also in this case, the optical head portion 134 may include one common focusing lens, and that focusing lens may irradiate the workpiece WP with the measurement light and receive the reflected light from the workpiece WP.

The combining portion 139 receives, from the circulator portion 125, the reflected light that is the measurement light radiated onto and reflected from the workpiece WP. Also, the combining portion 139 receives the reference light from the branching portion 120_{F}. The combining portion 139 combines/mixes the reflected measurement light and the reference light, and provides a corresponding output to the circuitry portion 102 (e.g., to a detector portion 140 in the circuitry portion 102, as will be described in more detail below with respect to FIG. 4). In various implementations, the combining portion 139 may be a fiber optic splitter (e.g., as may also be referenced as a fiber optic coupler and/or a fiber optic combiner).

For the reference light that travels along the reference optical path ROP_{F} (and as corresponding to a reference optical path length ROP_{L}), the reference light travels from the branching portion 120_{F}, through the optical fiber OF2 to the combining portion 139. For the measurement light that travels along the measurement optical path MOP_{F} (and as corresponding to a measurement optical path length MOPL), the measurement light travels from the branching portion 120_{F}, through the optical fiber OF3, through the circulator portion 125, through the optical fiber OF4, through the optical head portion 134, through free space FS to the workpiece WP (e.g., according to a distance D from the optical head portion 134 to the workpiece WP), and is reflected by the workpiece WP to travel back through the free space FS to the optical head portion 134 (e.g., according to the distance D from the optical head portion 134 to the workpiece WP), through the optical head portion 134, through the optical fiber OF4, through the circulator portion 125, and through the optical fiber OF5 to the combining portion 139.

In various implementations, in which the oscillation frequency of the light output from the light portion 110 changes linearly with the passage of time (e.g., as may be characterized as a frequency sweep), a frequency difference, which is dependent on a propagation delay corresponding to the difference in the propagation distance, occurs between the oscillation frequency of the reference light and the oscillation frequency of the measurement light (e.g., as received at the combining portion 139). A beat signal may be generated as corresponding to such a frequency difference (e.g., as generated according to the combining of the reference light and the measurement light, such as by the combining portion 139 of FIG. 3 or the branching portion/combining portion 120_{M} of FIG. 2). As will be described in more detail below with respect to FIG. 4, a detector and processing portion DPP of the circuitry portion 102 may include a detector portion 140 and may provide a signal that corresponds to the difference in the propagation distance between the reference light and the measurement light.

In various implementations, as will be described in more detail below with respect to FIG. 4, the detector and processing portion DPP detects the difference in the propagation distance between the reference light and the measurement light by frequency-analyzing the beat signal that is generated. More specifically, in various implementations, the combined light (e.g., from the combining portion 139) is received by a detector portion 140 (e.g., of the detector and processing portion DPP), which may output a combined light electrical signal (e.g., which may be sinusoidal), which is digitized utilizing an analog to digital converter (e.g., as may in some implementations be included in a processing portion 150 of the detector and processing portion DPP). This digitized signal may then be analyzed through a fast Fourier transform algorithm (e.g., as performed by the processing portion 150, and which in various implementations may perform additional processing for determining a distance to a workpiece).

In various implementations, a display portion 160 of the circuitry portion 102 is controlled by a control portion 180 to display the analysis result of the detector and processing portion DPP (e.g., as may display or otherwise indicate a distance to a workpiece, etc.). In various implementations, the display portion 160 may include a display or the like and display the detection result, and the control portion 180 may store the analysis result in a storage unit or the like. In general, the metrology system may measure a distance between the interferometer portion 101 and the workpiece WP by analyzing a frequency difference between the reference light and the measurement light as reflected from the workpiece WP, as will be described in more detail below.

In accordance with principles as described herein, the interferometer portion 101_{F} of the metrology system includes a dispersion portion DP_{F}. In the example of FIG. 3, the dispersion portion DP_{F} is included in the reference optical path ROP_{F}, although in certain alternative implementations the dispersion portion may be included in the measurement optical path MOP_{F}. In the illustrated example, the dispersion portion DP_{F} comprises a high dispersion optical fiber OF2 (i.e., for which the optical fiber OF2 which couples the branching portion 120_{F} to the combining portion 139 as described above is a high dispersion optical fiber). In various implementations, the other optical path (e.g., the measurement optical path MOP_{F}) may include one or more lower dispersion optical fibers (e.g., lower in relation to the high dispersion optical fiber OF2 of the dispersion portion DP_{F}). For example, some or all of the optical fibers OF3, OF4 or OF5 may be relatively lower dispersion optical fibers. This may be contrasted with certain conventional configurations, in which optical fibers may be included in both optical paths with similar/matched (e.g., identical) dispersion characteristics. As will be described in more detail below (e.g., with respect to FIGS. 5A-9), an imbalanced dispersion between the reference optical path and the measurement optical path results at least in part from the dispersion portion (e.g., as may be utilized as part of the process for determining a measurement distance to the workpiece WP).

Stated another way, in certain prior conventional configurations, matched optical fibers (e.g., with similar dispersion characteristics) in the reference and measurement optical paths have typically minimized cumulative unbalanced dispersion. Utilization of optical fibers with different dispersion characteristics (i.e., in accordance with principles as described herein) in the two optical paths will result in an unbalanced dispersion (e.g., which in some instances may correspond to an increase in an unbalanced dispersion). In such configurations, it is still desirable to match a baseline optical path length (OPL) for achieving the desired interference effects (e.g., as resulting from the combination of the reference and measurement light in the combining portion 139), but higher order phase can be added via dispersion. It is also noted that peak disambiguation (e.g., as described in more detail below) works in a single sweep, for which there is no relative reduction in acquisition speed for the measurement process (e.g., such as could occur in other approaches utilizing phase shifting and/or other such techniques). In various implementations, calibrated (e.g., traceable) dispersion may be added to the system to remove uncertainty in the phase correction term that is applied (e.g., as described in more detail below with respect to EQUATIONS 1-8, etc.).

In various implementations, an air gap (e.g., through free space FS, such as between the optical head portion 134 and the workpiece WP) may be utilized to deliver the measurement light to the workpiece WP. In some such configurations, it may be considered relatively more efficient to include relatively lower dispersion optical fiber(s) in the measurement optical path MOP (e.g., to enhance the dispersion mismatch created by the free space FS/air gap, such as relative to the reference optical path that may include a higher dispersion optical fiber). That being said, it will be appreciated that other configurations may also be utilized, with a primary goal in some such implementations being for the dispersion/optical fibers in the two optical paths to not be the same (e.g., having different dispersion characteristics), for which in general a greater dispersion mismatch may result in better disambiguation between signal peaks (e.g., as will be described in more detail below with respect to FIGS. 5A-9).

FIG. 4 is a block diagram illustrating an implementation of the circuitry portion 102 as may be included in a metrology system such as that of FIG. 1. As shown in FIG. 4, the circuitry portion 102 includes a detector and processing portion DPP (e.g., including a detector portion 140 and a processing portion 150), a display portion 160, and a control portion 180. In various implementations, the detector portion 140 of the detector and procession portion DPP receives/detects the combined reference and measurement light (e.g., as received from the branching portion 120_{M} of FIG. 2 or the combining portion 139 of FIG. 3) and converts the combined light into an electrical signal. In various implementations, the detector portion 140 detects a beat signal that is generated by combining and interfering the reference light and the measurement light. In various implementations, the detector portion 140 may have, for example, a photoelectric conversion element, and may convert the beat signal into an electrical signal. One example of the photoelectric conversion element is a photodiode. The detector and processing portion DPP may also have an analog-to-digital converter (ADC), which may convert/digitize the beat signal converted into an electrical signal into a digital signal.

As described above, in various implementations the oscillation frequency of the light output by the light portion 110 changes linearly over time. Therefore, a frequency difference occurs between the oscillation frequency of the reference light and the oscillation frequency of the measurement light according to the propagation delay. A beat signal is generated as corresponding to this frequency difference.

The processing portion 150 (e.g., including a calculation portion) analyzes the detected electrical signal to calculate the distance D to the workpiece WP. The processing portion 150 analyzes the frequency at which the beat signal is generated, for example, by using frequency conversion such as FFT. Then, the processing portion 150 calculates the optical path length difference corresponding to the frequency of the beat signal.

In various implementations, the control portion 180 receives the output from the processing portion 150 of the detector and processing portion DPP, and controls the display portion 160 to display the analysis results of the processing portion 150. The display portion 160 may have a display or the like and display the detection results. The display portion 160 may also receive instructions from a user. In various implementations, the control portion 180 may be configured to control certain operations of the light portion 110, the display portion 160, and/or the detector and processing portion DPP. In various implementations, the control portion 180 may control the light portion 110 to output the light to the branching portion 120 (e.g., of FIG. 2 or FIG. 3). In general, it is noted that the metrology system 100 including the interferometer portion 101 and the circuitry portion 102 is capable of measuring a distance between the metrology system 100 and the workpiece WP (e.g., by analyzing the frequency difference between the measurement light reflected by the workpiece WP and the reference light).

As noted above, in accordance with principles as described herein, the interferometer portion 101 (e.g., the interferometer portion 101_{M} of FIG. 2 or 101_{F} of FIG. 3) of the metrology system includes a dispersion portion DP (e.g., the dispersion portion DP_{M} of FIG. 2 or DP_{F} of FIG. 3). As will be described in more detail below (e.g., with respect to FIGS. 5A-9), an imbalanced dispersion between a reference optical path ROP and a measurement optical path MOP results at least in part from the dispersion portion. More specifically, the dispersion portion DP may result in a dispersion of the light in the reference optical path ROP that is different than a dispersion of the light in the measurement optical path MOP, as corresponding to the imbalanced dispersion between the reference optical path ROP and the measurement optical path MOP (e.g., as may be utilized as part of the process for determining a measurement distance to the workpiece WP).

FIGS. 5A-5D are diagrams illustrating certain operating principles of a metrology system such as that of FIG. 1. As noted above, in various implementations the metrology system, including the light portion 110, is operated according to optical coherence tomography (OCT), such as frequency-modulated continuous wave (FMCW), which in some implementations may also be referenced as swept source optical coherence tomography (SS-OCT). FIG. 5A illustrates a condition in which a measurement distance (e.g., to a workpiece) is such that a measurement optical path length MOPL is longer than a reference optical path length ROP_{L}. An optical path length difference DIFF is shown which corresponds to the difference between the optical path lengths. For example, where MOPL is 1.5 mm longer than ROP_{L}, MOPL may correspond to a position of 1.5 mm in a range of −4.0 mm to +4.0 mm, for which distance D from the interferometer portion 101 (see FIG. 4) might be +5.5 mm, which spans from the −4.0 mm end of the negative range to +1.5 mm in the positive range (e.g., in a configuration where the range starts at an edge of the interferometer portion 101).

FIG. 5B is a graph illustrating changing frequencies versus time, with a dotted line signal corresponding to the measurement light ML, and a solid line signal corresponding to the reference light RL (e.g., as received at a combining portion, such as combining portion 139). The shape of each signal is in accordance with the swept frequency of the light portion 110 (e.g., where the frequency of each signal increases linearly over time, up to a maximum at which point the frequency returns to the baseline level, after which the process may repeat during future time periods). A time delay ΔT between the signals is shown to be greater than 0, as corresponding to the propagation delay (e.g., due to the measurement optical path length MOPL being longer than the reference optical path length ROP_{L}). A beat frequency f_{b} is also shown to correspondingly be greater than zero, and as corresponding to a difference in frequency between the two signals at a given time, as illustrated in FIG. 5B.

FIG. 5C is a graph of a combined signal (e.g., from the combining portion), for which the amplitude is indicated to oscillate over time. Due to the swept frequency of the light portion 110, the time delay (e.g., as illustrated in FIG. 5B) is encoded in the beat frequency f_{b} of the signal of FIG. 50, when the reference light and the measurement light are combined (e.g., by the combining portion). In various implementations, the beat frequency may be detected as a function of time (e.g., by the detector portion 140 of the detector and processing portion DPP). In various implementations, a Fourier transform (e.g., as utilized by the processing portion 150) can evaluate the time domain data and extract any frequency information. Since the rate of change in the frequency (i.e., the slope of the frequency sweep) is known, the frequency information may be mapped to distance traveled by the light (e.g., as indicated in FIG. 5D, which shows signal peaks as corresponding to different workpiece distances/positions D).

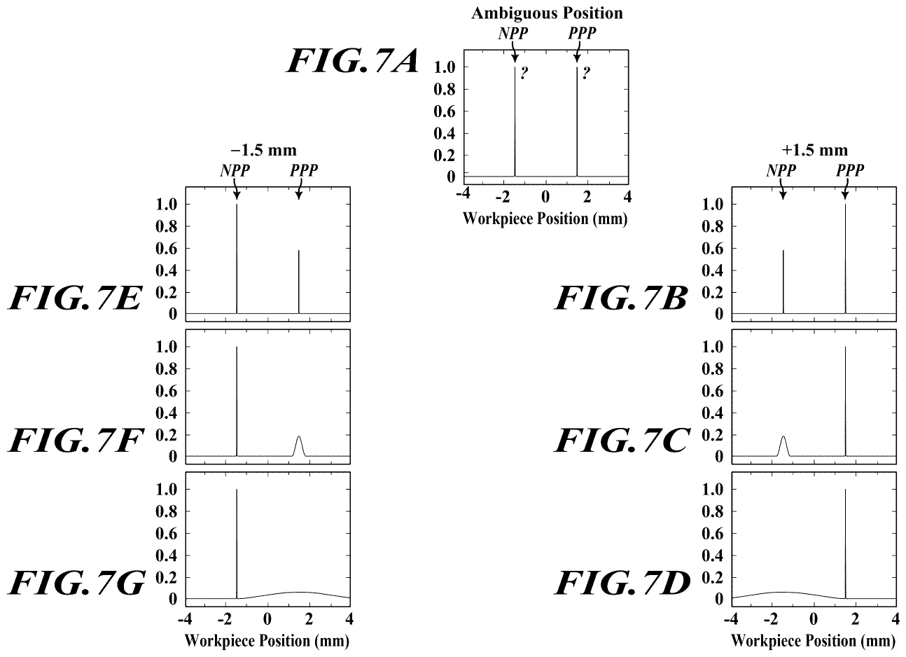

In further regard to FIG. 5D (i.e., for which the x-axis extends over a range from −4.0 mm to +4.0 mm), it is noted that the Fourier transform used to convert frequency space to distance produces + and − conjugate peak pairs (i.e., as corresponding to a positive position peak PPP and a negative position peak NPP, and as corresponding to a positive beat frequency +f_{b}, and a negative beat frequency −f_{b}, respectively). In general, standard processing for such systems has typically ignored the negative component (e.g., for which the measurement optical path length MOPL is always assumed/configured to be greater than the reference optical path length ROP_{L}). In such systems, collecting data in the negative distance range has been considered undesirable due to the ambiguity in the signal peaks (i.e., in regard to which signal peak corresponds to the current measurement). In such systems, this has effectively reduced the usable distance range by approximately ½ (e.g., in the present example, utilizing only a 4 mm distance range as corresponding to the positive signal range from 0 to 4 mm, as opposed to the full 8 mm distance range as would correspond to the combination of the negative and positive distance ranges from −4.0 mm to +4.0 mm). In various implementations, in order to address such issues, in accordance with principles as described herein the metrology system may include a dispersion portion (e.g., which enables disambiguation between the signal peaks, as will be described in more detail below with respect to FIGS. 7A-9).

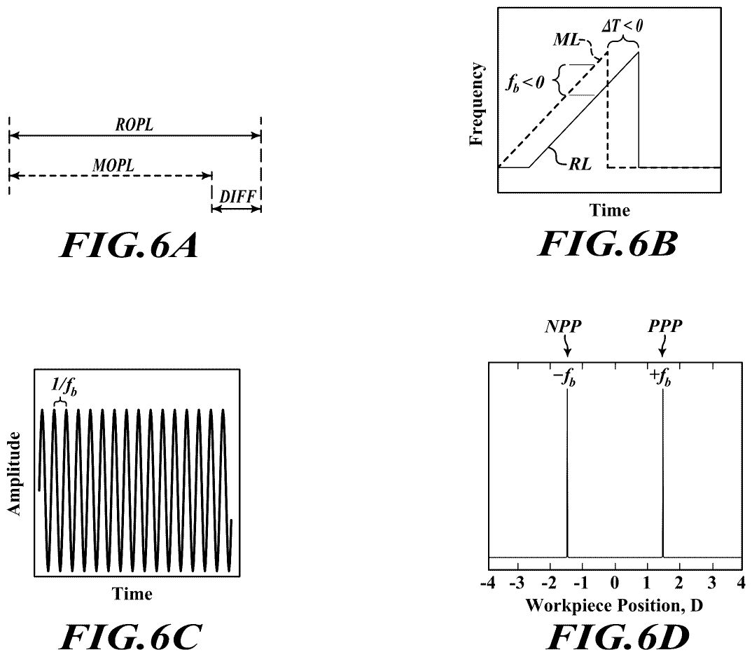

FIGS. 6A-6D are diagrams similar to the diagrams of FIGS. 5A-5D, respectively, except as corresponding to a reversed condition (i.e., with respect to the lengths MOPL and ROP_{L}). More specifically, FIG. 6A illustrates a condition in which a measurement distance (e.g., to a workpiece) is such that a measurement optical path length MOPL is shorter than a reference optical path length ROP_{L}. An optical path length difference DIFF is shown which corresponds to the difference between the optical path lengths (e.g., for which as a simplified example, the magnitude of the optical path length difference DIFF of FIG. 6A may be the same as the magnitude of the optical path length difference DIFF of FIG. 5A). For example, where MOPL is 1.5 mm shorter than ROP_{L}, MOPL may correspond to a position of −1.5 mm in a range of −4.0 mm to +4.0 mm, for which distance D from the interferometer portion 101 (see FIG. 4) might be +2.5 mm, which spans from the −4.0 mm end of the negative range to −1.5 mm in the negative range (e.g., in a configuration where the range starts at an edge of the interferometer portion 101).

In FIG. 6B (i.e., which is similar to FIG. 5B except with reversed relative signal positions), a dotted line signal corresponds to the measurement light ML, and a solid line signal corresponds to the reference light RL (e.g., as received at a combining portion). A time delay ΔT between the signals is shown to be less than 0, as corresponding to the propagation delay (e.g., due to the measurement optical path length MOPL being shorter than the reference optical path length ROP_{L}). A beat frequency f_{b} is also shown to correspondingly be less than zero, and as corresponding to a difference in frequency between the two signals at a given time, as illustrated in FIG. 6B.

In FIG. 6C, the time delay (e.g., as illustrated in FIG. 6B) is encoded in the beat frequency f_{b} of the signal of FIG. 6C, when the reference light and the measurement light are combined (e.g., by the combining portion). In various implementations, similar to the process described above with respect to FIGS. 5C and 5D, the beat frequency may be detected as a function of time (e.g., by the detector portion 140 of the detector and processing portion DPP). The frequency information may be mapped to distance traveled by the light (e.g., as indicated in FIG. 6D, which shows signal peaks as corresponding to different workpiece distances/positions D).

In further regard to FIG. 6D, it is noted that the Fourier transform used to convert frequency space to distance produces + and − conjugate peak pairs (i.e., as corresponding to a positive position peak PPP and a negative position peak NPP, and as corresponding to a positive beat frequency +f_{b}, and a negative beat frequency −f_{b}, respectively). The produced positive and negative signal peaks are noted to basically be identical to those of FIG. 5B. Due at least in part to the corresponding ambiguity between the signal peaks, as noted above (i.e., with respect to standard processing in previous systems), collecting data in the negative distance range has been considered undesirable (i.e., in regard to ambiguity as to which signal peak corresponds to the current measurement). More specifically, if a measurement process is performed which results in the positive position peak PPP and the negative position peak NPP at the indicated positions (i.e., as corresponding to +1.5 mm and − 1.5 mm, respectively, as shown in FIGS. 5D and 6D), it may be unclear if the measurement corresponds to the positive position peak PPP at the +1.5 mm position or the negative position peak NPP at the −1.5 mm position (e.g., as corresponding to the difference between the measurement optical path length MOPL and the reference optical path length ROP_{L}). As noted above, in various implementations, in order to address such issues, in accordance with principles as described herein the metrology system may include a dispersion portion (e.g., which enables disambiguation between the signal peaks, as will be described in more detail below with respect to FIGS. 7A-9).

FIGS. 7A-7G are diagrams illustrating certain operating principles of a metrology system such as that of FIG. 1 and in which inclusion of a dispersion portion enables utilization of a full measurement range. FIG. 7A is similar to FIGS. 5D and 6D, and illustrates a condition in which it is ambiguous/unclear as to which of the two signal peaks (i.e., as corresponding to a positive position peak PPP and a negative position peak NPP, and as corresponding to a positive beat frequency +f_{b}, and a negative beat frequency −f_{b}, respectively), a current measurement/position corresponds to.

FIGS. 7B-7D illustrate a condition in which a current measurement/position corresponds to a positive position peak PPP (e.g., with a measurement optical path length MOPL longer than a reference optical path length ROP_{L}, similar to that of FIG. 5A), and with increasing dispersion (e.g., as provided by a dispersion portion) resulting in greater effects on the signals. More specifically, FIG. 7B corresponds to a relatively lower level of dispersion (e.g., resulting from a dispersion portion that provides a relatively lower level of dispersion), which is illustrated to correspond to a reduction in the intensity of the negative position peak NPP (e.g., reduced from an intensity of approximately 1 down to an intensity of approximately 0.6). FIG. 7D corresponds to a relatively higher level of dispersion (e.g., resulting from a dispersion portion that provides a relatively higher level of dispersion), which is illustrated to correspond to a reduction in the intensity of the negative position peak NPP (e.g., reduced from an intensity of approximately 1 down to an intensity of less than 0.1, which may also be characterized as less than 10%, such as in comparison to the intensity of the negative position peak NPP in FIG. 7A).

FIG. 7C corresponds to an in-between level of dispersion (e.g., in-between the levels of dispersion of FIGS. 7B and 7D, as resulting from a dispersion portion that provides an in-between level of dispersion), which is illustrated to correspond to a reduction in the intensity of the negative position peak NPP (e.g., reduced from an intensity of approximately 1 down to an intensity of approximately 0.2). It will be appreciated that the examples of FIGS. 7B-7D illustrate how the reductions in intensity of the negative position peak NPP may correspond to a disambiguation between the two position peaks and enables the current measurement/position to be correctly associated with the positive position peak PPP (e.g., as enabling a determination of a distance to a workpiece, whereas without such techniques it would be unclear if the distance to the workpiece should be associated with/correspond to the positive or negative position peak).

FIGS. 7E-7G illustrate a condition in which a current measurement/position corresponds to a negative position peak NPP (e.g., with a measurement optical path length MOPL shorter than a reference optical path length ROP_{L}, similar to that of FIG. 6A), and with increasing dispersion (e.g., as provided by a dispersion portion) resulting in greater effects on the signals. More specifically, FIG. 7E corresponds to a relatively lower level of dispersion (e.g., resulting from a dispersion portion that provides a relatively lower level of dispersion), which is illustrated to correspond to a reduction in the intensity of the positive position peak PPP (e.g., reduced from an intensity of approximately 1 down to an intensity of approximately 0.6). FIG. 7G corresponds to a relatively higher level of dispersion (e.g., resulting from a dispersion portion that provides a relatively higher level of dispersion), which is illustrated to correspond to a reduction in the intensity of the positive position peak PPP (e.g., reduced from an intensity of approximately 1 down to an intensity of less than 0.1, which may also be characterized as less than 10%, such as in comparison to the intensity of the positive position peak PPP in FIG. 7A).

FIG. 7F corresponds to an in-between level of dispersion (e.g., in-between the levels of dispersion of FIGS. 7E and 7G, as resulting from a dispersion portion that provides an in-between level of dispersion), which is illustrated to correspond to a reduction in the intensity of the positive position peak PPP (e.g., reduced from an intensity of approximately 1 down to an intensity of approximately 0.2). It will be appreciated that the examples of FIGS. 7E-7G illustrate how the reductions in intensity of the positive position peak PPP may correspond to a disambiguation between the two position peaks and enables the current measurement/position to be correctly associated with the negative position peak NPP (e.g., as enabling a determination of a distance to a workpiece, whereas without such techniques it would be unclear if the distance to the workpiece should be associated with/correspond to the positive or negative position peak).

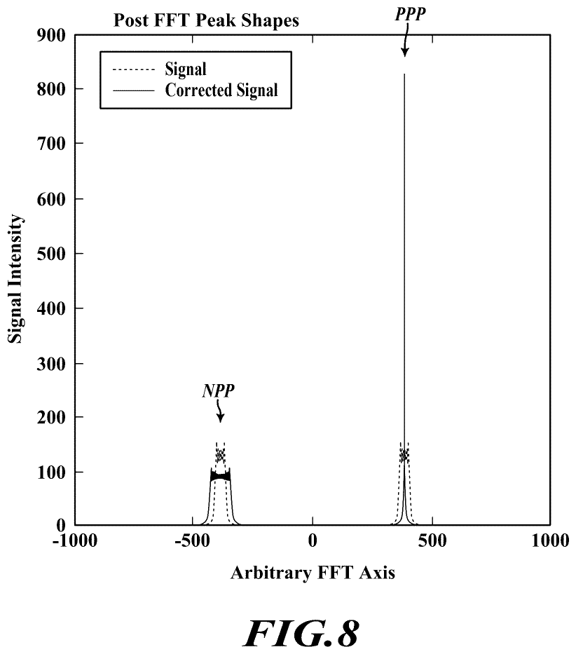

In relation to the effects illustrated in FIGS. 7B-7D and 7E-7G, as a general principle (e.g., and as will be described in more detail below with respect to FIG. 8), imbalanced dispersion between the reference optical path ROP and the measurement optical path MOP (e.g., due to inclusion of a dispersion portion in one of the optical paths) results in a phase buildup in the signal, and a broadening of the resulting signal peaks. Correcting for the phase imbalance numerically after the data collection results in proper peak recreation in one side (i.e., which corresponds to the measurement) while broadening the conjugate peak even further. Purposefully adding a significant amount of dispersion mismatch into the system (e.g., including a dispersion portion DP in the reference optical path ROP or the measurement optical path MOP) and then correcting for it during processing, can suppress the conjugate peak significantly, thus allowing the entire +/−measurement/distance range (e.g., from −4.0 mm to +4.0 mm) to be utilized without ambiguous signal peaks. Certain equations related to such techniques will be described in more detail below.

FIG. 8 is a diagram illustrating two signal peaks with different peak shapes and intensities as resulting from utilization of a dispersion portion and subsequent processing. In some implementations, the example of FIG. 8 may be considered somewhat analogous to the example of FIG. 7C (e.g., with a condition in which a current measurement/position corresponds to a positive position peak PPP). As noted above and as indicated in FIG. 8, a dispersion portion DP has resulted in a phase buildup in the signal, and a broadening of the resulting signal peaks (i.e., for both the positive and negative position peaks PPP and NPP, as shown for the signal which has a dotted line representation in FIG. 8). Correcting for the phase imbalance numerically after the data collection (i.e., as indicated by the corrected signal in FIG. 8 as shown with a solid line representation) results in proper peak recreation in one side (i.e., in this example in the positive position peak PPP which corresponds to the measurement) while broadening the conjugate peak even further (i.e., in this example further broadening the negative position peak NPP, such as further broadened by approximately 2×). Certain equations related to such processes include:

$$Signal = cos ( {ω}_{b} + ϕ ) \qquad ( Eq . 1 )$$

where ω_{b} is the detected beat frequency, and φ is the phase due to dispersion, and the signal is as indicated in FIG. 8 (i.e., with the dotted line representation). A dispersion correction term may be represented as:

$$Dispersion Correction = exp ( - i ϕ ) \qquad ( Eq . 2 )$$

A corrected signal term (as corresponding to the corrected signal in FIG. 8 and with the dispersion correction of EQUATION 2 as applied to the signal of EQUATION 1) is:

$$Corrected Signal = cos ( {ω}_{b} + ϕ ) * exp ( - i ϕ ) \qquad ( Eq . 3 )$$

An expression indicating a general expansion of a cosine term (i.e., indicating an expansion of cos (a), with (a) as a general representative variable), is:

$$cos ( a ) = \frac{1}{2} exp ( - i a ) + \frac{1}{2} exp ( i a ) \qquad ( Eq . 4 )$$

The application of EQUATION 4 (e.g., as substituted into EQUATION 3) results in:

$$Corrected Signal = [ \frac{1}{2} exp ( - i ( {ω}_{b} + ϕ ) ) + \frac{1}{2} exp ( i ( {ω}_{b} + ϕ ) ) ] * exp ( - i ϕ ) \qquad ( Eq . 5 )$$

Further rearranging of EQUATION 5 results in:

$$Corrected Signal = \frac{1}{2} exp ( - i {ω}_{b} - i ϕ ) * exp ( - i ϕ ) + \frac{1}{2} exp ( i {ω}_{b} + i ϕ ) * exp ( - i ϕ ) \qquad ( Eq . 6 )$$

Further rearranging of EQUATION 6 results in:

$$Corrected signal = \frac{1}{2} exp ( - i {ω}_{b} - i ϕ - i ϕ ) + \frac{1}{2} exp ( i {ω}_{b} + i ϕ - i ϕ ) \qquad ( Eq . 7 )$$

Further rearranging of EQUATION 7 results in:

$$Corrected signal = \frac{1}{2} exp ( - i {ω}_{b} - 2 i ϕ ) + \frac{1}{2} exp ( i {ω}_{b} ) \qquad ( Eq . 8 )$$

As noted above, and in relation to the EQUATION 8, correcting for the phase imbalance numerically after the data collection (i.e., as indicated by the corrected signal in FIG. 8) results in proper peak recreation in one side (i.e., in this example in the positive position peak PPP which corresponds to the measurement) while broadening the conjugate peak even further (i.e., in this example further broadening the negative position peak NPP, such as further broadened by approximately 2×). Thus, the inclusion of the dispersion portion in the system (e.g., along with subsequent processing such as that described above), enables disambiguation between the positive and negative position peaks (i.e., the signal peaks in a distance indicating electrical signal), which enables a detector and processing portion to determine a distance to a workpiece.

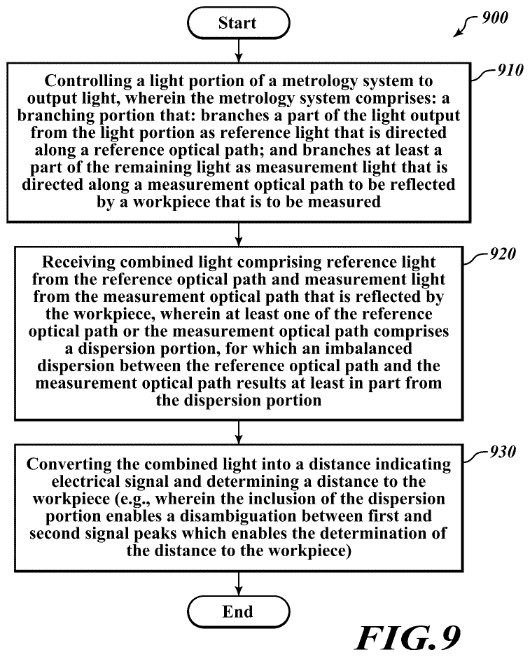

FIG. 9 is a flow diagram illustrating an exemplary implementation of a routine 900 for operating a metrology system. At a block 910, a light portion of a metrology system is controlled to output light, wherein the metrology system comprises: a branching portion that: branches a part of the light output from the light portion as reference light that is directed along a reference optical path; and branches at least a part of the remaining light as measurement light that is directed along a measurement optical path to be reflected by a workpiece that is to be measured. At a block 920, combined light is received comprising reference light from the reference optical path and measurement light from the measurement optical path that is reflected by the workpiece, wherein at least one of the reference optical path or the measurement optical path comprises a dispersion portion, for which an imbalanced dispersion between the reference optical path and the measurement optical path results at least in part from the dispersion portion. At a block 930, the combined light is converted into a distance indicating electrical signal and a distance to the workpiece is determined (e.g., wherein the inclusion of the dispersion portion enables a disambiguation between first and second signal peaks which enables the determination of the distance to the workpiece).

As noted above, in a precision metrology system for measuring a distance to a workpiece, when attempting to utilize full range detection, a problem exists of ambiguous peaks (e.g., in collected optical coherence tomography (OCT) data, such as frequency-modulated continuous wave (FMCW) data). In various implementations, such issues may reduce the effective measurement range by a factor of 2 (e.g., in accordance with only enabling utilizing of the positive portion of the measurement range). As described herein, such issues may be addressed by an intentional addition of a dispersion portion DP (e.g., including dispersive material) into the interferometer portion 101 (e.g., and utilizing subsequent numerical correction/processing to clearly disambiguate the correct signal peak as corresponding to the current measurement). In various implementations, this may effectively double the OCT (e.g., FMCW) useable range of certain prior systems with minimal effect on the sensitivity and no change to the data collection rate.

As described above, in accordance with such principles, a dispersion portion DP (e.g., the dispersion portion DP_{M} of FIG. 2 or the dispersion portion DP_{F} of FIG. 3) may be included in the reference optical path ROP or the measurement optical path MOP of the interferometer portion 101. The inclusion of the dispersion portion DP enables the disambiguation between the first and second signal peaks (e.g., as corresponding to a negative position peak NPP and a positive position peak PPP) in the distance indicating electrical signal (e.g., and a corresponding indication/determination as to whether the measurement optical path MOP is longer or shorter than the reference optical path ROP, for which longer corresponds to the positive position peak PPP, while shorter corresponds to the negative position peak NPP), which enables the detector and processing portion DPP to determine a distance to the workpiece. Such techniques enable utilization of the full measurement range of the system (e.g., in contrast to only utilizing the positive portion of the measurement range, as done in certain prior systems, such as due to an inability to distinguish/disambiguate between the two signal peaks).

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein. In addition, the various implementations described above can be combined to provide further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

What is claimed is:

1. A metrology system, comprising:
a light portion that outputs light;
a branching portion that:
branches a part of the light output from the light portion as reference light that is directed along a reference optical path; and
branches at least a part of the remaining light as measurement light that is directed along a measurement optical path to be reflected by a workpiece that is to be measured; and
a detector and processing portion configured to:
receive combined light comprising reference light from the reference optical path and measurement light from the measurement optical path that is reflected by the workpiece; and
convert the combined light into a distance indicating electrical signal;
wherein at least one of the reference optical path or the measurement optical path comprises a dispersion portion, for which an imbalanced dispersion between the reference optical path and the measurement optical path results at least in part from the dispersion portion.

2. The metrology system of claim 1, wherein the dispersion portion comprises a higher dispersion optical fiber that is included as at least part of either the reference optical path or the measurement optical path, and the other optical path includes one or more lower dispersion optical fibers.

3. The metrology system of claim 1, wherein the detector and processing portion is further configured to analyze the distance indicating electrical signal and determine a distance to the workpiece.

4. The metrology system of claim 3, wherein the inclusion of the dispersion portion enables a disambiguation between first and second signal peaks in the distance indicating electrical signal, which enables the detector and processing portion to determine the distance to the workpiece.

5. The metrology system of claim 1, wherein the detector and processing portion comprises:
a detector portion that receives the combined light and outputs an electrical signal; and
a processing portion that receives and analyzes the electrical signal and calculates the distance to the workpiece.

6. The metrology system of claim 1, further comprising an optical head portion which as a part of the measurement optical path directs light through free space to the workpiece and receives measurement light that is reflected by the workpiece.

7. The metrology system of claim 6, wherein as part of the measurement optical path a measurement path optical fiber provides light to the optical head portion and receives the measurement light from the optical head portion.

8. The metrology system of claim 1, further comprising a combining portion that receives and combines reference light from the reference optical path and measurement light from the measurement optical path, wherein the detector and processing portion receives the combined light from the combining portion.

9. The metrology system of claim 8, wherein as part of the reference optical path, the reference light travels through a reference path optical fiber to the combining portion, and as part of the measurement optical path, the measurement light travels through a measurement path optical fiber to the combining portion.

10. The metrology system of claim 1, wherein the reference optical path includes the dispersion portion that results in a higher dispersion of the light in the reference optical path as compared to the dispersion of the light in the measurement optical path.

11. A method for operating a metrology system,
the metrology system comprising:
a light portion that outputs light; and
a branching portion that:
branches a part of the light output from the light portion as reference light that is directed along a reference optical path; and
branches at least a part of the remaining light as measurement light that is directed along a measurement optical path to be reflected by a workpiece that is to be measured;
the method comprising:
receiving combined light comprising reference light from the reference optical path and measurement light from the measurement optical path that is reflected by the workpiece, wherein at least one of the reference optical path or the measurement optical path comprises a dispersion portion, for which an imbalanced dispersion between the reference optical path and the measurement optical path results at least in part from the dispersion portion; and
converting the combined light into a distance indicating electrical signal and determining a distance to the workpiece.

12. The method of claim 11, wherein the dispersion portion comprises a higher dispersion optical fiber that is included as at least part of either the reference optical path or the measurement optical path, and the other optical path includes one or more lower dispersion optical fibers.

13. The method of claim 11, further comprising analyzing the distance indicating electrical signal and determining a distance to the workpiece.

14. The method of claim 13, wherein the inclusion of the dispersion portion enables a disambiguation between first and second signal peaks, which enables the determination of the distance to the workpiece.

15. The method of claim 11, wherein the metrology system further comprises an optical head portion which as a part of the measurement optical path directs light through free space to the workpiece and receives measurement light that is reflected by the workpiece.

16. The method of claim 15, wherein as part of the measurement optical path a measurement path optical fiber provides light to the optical head portion and receives the measurement light from the optical head portion.

17. A metrology system, comprising:
a light portion that outputs light; and
a branching portion that:
branches a part of the light output from the light portion as reference light that is directed along a reference optical path; and
branches at least a part of the remaining light as measurement light that is directed along a measurement optical path to be reflected by a workpiece that is to be measured;
wherein the metrology system is configured to:
receive combined light comprising reference light from the reference optical path and measurement light from the measurement optical path that is reflected by the workpiece; and
convert the combined light into a distance indicating electrical signal;
wherein at least one of the reference optical path or the measurement optical path comprises a dispersion portion, for which an imbalanced dispersion between the reference optical path and the measurement optical path results at least in part from the dispersion portion.

18. The metrology system of claim 17, wherein the dispersion portion comprises a higher dispersion optical fiber that is included as at least part of either the reference optical path or the measurement optical path, and the other optical path includes one or more lower dispersion optical fibers.

19. The metrology system of claim 17, wherein the system is further configured to analyze the distance indicating electrical signal and determine a distance to the workpiece.

20. The metrology system of claim 19, wherein the inclusion of the dispersion portion enables a disambiguation between first and second signal peaks in the distance indicating electrical signal, which enables the determination of the distance to the workpiece.
